(19) United States
(12) Patent Application Publication
(10) Pub. No.: US 2008/0094571 A1
(43) Pub. Date: Apr. 24, 2008

(54) Method and system for determining characteristics of lenses adapted for use with computers

(76) Inventor: Larry Tarrant, Sunnyvale, TX (US)

Correspondence Address: STORM LLP, BANK OF AMERICA PLAZA, 901 MAIN STREET, SUITE 7100, DALLAS, TX, 75202, US

(21) Appl. No.: 11/583,561

(22) Filed: Oct. 19, 2006

(51) Int. Cl. G02C 7/06

(52) U.S. Cl. 351/169

(57) ABSTRACT

Over the years, eyestrain and headaches have become an increasing problem for computer users, especially those who require eyeglasses. To combat this problem, lenses and a method/system for calculating the characteristics of these lenses have been developed. The method/system takes age, height, and the user's or wearer's prescription into account to help optometrists grind lenses that are specifically adapted for use with computers. Therefore, it is now possible to have an automated system that determines characteristics for lenses that are adapted for use with computers.

### TECHNICAL FIELD

The invention relates generally to determining eyeglass lens characteristics and, more particularly, to a method of determining characteristics for lenses adapted for use with computers.

### BACKGROUND

Eyeglasses have been a medical fixture for centuries. As a result of many years of research, two basic lenses are employed: spherical lenses and cylindrical lenses. A spherical lens has the same general uniform curvature over the surface of the lenses whereas the cylindrical lens has a uniform curve relative to an axis. Each of these two lenses is further defined by type as being positive (convex) and negative (concave). The power of such lenses is varied by changing the curvature and shape of the lenses and is measured in diopters, where one diopter is a focal length of one meter. Determining such characteristics for eyeglass lenses is very precise, and this total power/curvature (prescription) is defined by the following equation:

OD/OS=A±B×Cplus±D. (1)

OD (right eye) and OS (left eye) designate to total lens strength. “A” is the spherical base curve and type (positive or negative). “×B×C” denotes the cylindrical strength, type, and axis orientation, and “plus±D” indicates bifocal segment strength. Lenses, though, have been specifically refined for “everyday use.”

Increasingly, however, eye strain and headaches have been a frequent problem for many people who use a computer monitor for long periods of time, especially for people who wear eyeglasses. As a result, glasses for use with computers have been developed and sold, but determining the correct optical characteristics for them has been the result of trial and error or guesswork. Some prior-art examples of methods and systems for providing or determining lens characteristics are U.S. Pat. Nos. 5,204,702, 5,661,539, 6,345,893, 6,592,223, 6,709,101, and 6,726,327 and U.S. patent Publication Nos. 2003/0218721, 2005/0122472, 2005/0231683, and 2005/0270482. None of these reference discloses an automated method or system for calculating characteristics for lenses adapted for use with a computer.

Therefore, there is a need for a method and/or system that automatically determines the characteristics of lenses adapted for use with computers.

### SUMMARY

A preferred embodiment of the present invention, accordingly, provides a method and system for determining characteristics for lenses adapted for use with computers. A plurality of physical characteristics of a human user are input into the system, where the physical characteristics at least include a distance prescription and a work distance. A corrected age and a height factor are each calculated from at least one of the physical characteristics, and a computer work distance prescription is calculated. The computer work distance prescription is a function of a ratio of the corrected age and work distance the distance prescription, and the height factor.

In accordance with a preferred embodiment of the present invention, the calculation of the corrected age further comprises determining an age of the user and assigning a value. If the user's age is less than 30, then the corrected age is 30. If the user's age is between 30 and 60, the corrected age is the user's age. Finally, if the user's age is greater than or equal to 60 the corrected age is 60.

In accordance with a preferred embodiment of the present invention, the calculation of the height factor further comprises determining a height of the user and assigning a value. If the user's height is greater than or equal to 75 inches, the height factor is zero, and if the user's height is less than or equal to 75 inches, the height factor is calculated as a function of the user's height.

In accordance with a preferred embodiment of the present invention, the calculation of the computer work distance prescription further comprises summing the ratio of the corrected age and work distance, the distance prescription, and the height factor.

In accordance with a preferred embodiment of the present invention, a work distance and a distance prescription for the user are established.

In accordance with a preferred embodiment of the present invention, the calculation of the computer work distance prescription further comprises calculating the lens power by summing one percent of the ratio of the corrected age and work distance with the height factor and the distance prescription.

A preferred embodiment of the present invention, accordingly, also provides a lens for a human user adapted for use with computers comprising a refractive material having a first side and an opposite second side. Each of the first and second sides has a topology and an arcuate profile, and the topologies and arcuate profiles of the first and the second sides are functions of a ratio of a corrected age and a work distance of the user, a distance prescription of the user, and a height factor of the user.

In accordance with a preferred embodiment of the present invention, the lens is tinted blue, yellow, rose, or lavender.

In accordance with a preferred embodiment of the present invention, the corrected age is 30 (if a user's age is less than 30), the user's age (if the user's age is greater than 30 but less than 60), or 60 (if the user's age is greater than or equal to 60).

In accordance with a preferred embodiment of the present invention, the height factor is 0 (if the user's height is greater than or equal to 75 inches) or a function of the user's height for all heights less than 75 inches.

In accordance with a preferred embodiment of the present invention, the topologies and arcuate profiles of the first and the second sides are a sum of the ratio of the corrected age and work distance, the distance prescription, and the height factor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a cross-sectional view of a lens adapted for use with eyeglasses worn by a computer user in accordance with a preferred embodiment of the present invention;

FIG. 1B is a front elevation view of the lens of FIG. 1A; and

FIGS. 2A and 2B are flow charts depicting the method for calculating the characteristics of lenses adapted for use with computers of FIGS. 1A and 1B.

### DETAILED DESCRIPTION

In the discussion of the Figures the same reference numerals will be used throughout to refer to the same or similar components.

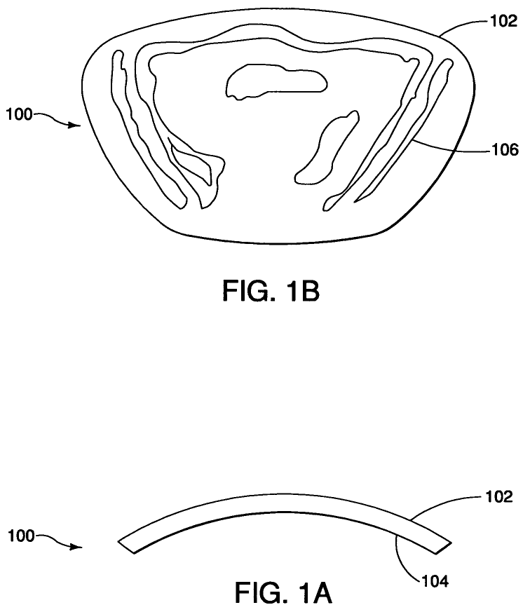

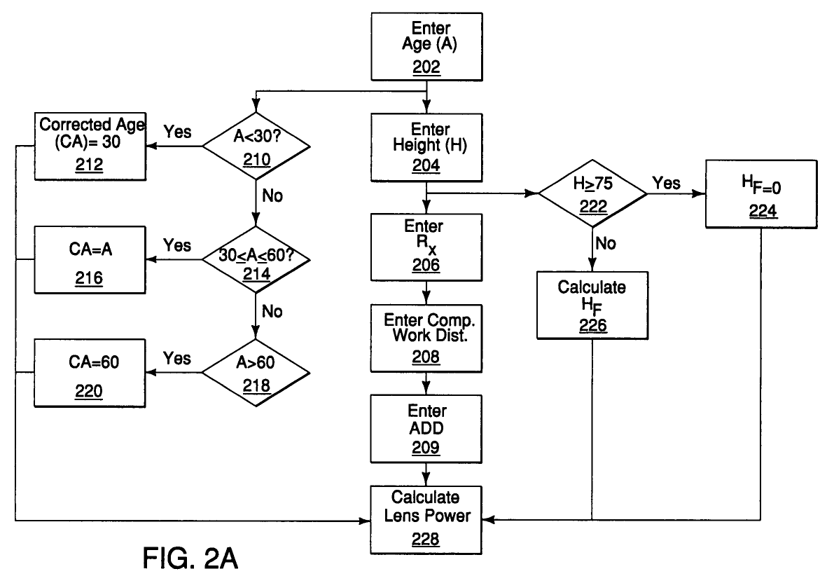

Referring to FIGS. 1A and 1B of the drawings, the reference numeral 100 generally designates a lens. Specifically, the lens 100 is adapted for use in eyeglasses worn by a computer user. As with conventional eyeglass lenses, lens 100 is made of refractive or transparent materials, such as glass or plastic. The lenses (such as lens 100) are, preferably, ground or molded to form optical lenses that have different focal lengths and other optical characteristics based on the needs of the wearer. Conventional eyeglass lenses are then used to treat such conditions as myopia, hyperopia, astigmatism or presbyopia.

Also, as with conventional eyeglass lenses, lens 100 has topologies and arcuate profiles to refract light as needed for the specific wearer. Lens 100 comprises a first side 102 that is designed to receive light from a source and an opposite second side 104 that faces the wearer. Each of the sides 102 and 104 has a distinct arcuate profile or curvature(s), which can be seen in FIG. 1A. As can be seen in FIG. 1B, contour lines 106 are shown on first side 102, which depict the different elevations or contours that appear and denote curvature. The combination of these contour features (depicted by contour lines 106) constitutes the topology of the first side 102. In addition, the surfaces of one or both of sides 102 and 104 are not necessarily smooth, such as some bifocal and trifocal lenses.

In addition to having different topologies and arcuate profiles, the lens can also be tinted according to the lighting requirements of the user. It has been known to tint lenses for a long period of time, but tinting was primarily done for aesthetic reasons and not functional ones. However, it has been found that having a slightly (and even a heavy) blue tint for florescent lighting conditions assists in reducing headaches and eyestrain, while yellow, rose, or lavender are better suited for incandescent lighting. Thus, it is also advantageous to provide a blue, yellow, rose, or lavender tint in lens 100.

Conventionally, lenses are ground or formed to treat vision deficiencies such as nearsightedness, farsightedness, astigmatisms, or the like. Different regions of the lenses may have different characteristics for different vision problems, for example bifocal and trifocal lenses that have lower regions formed to address near-vision defects and upper regions formed to address far-vision defects.

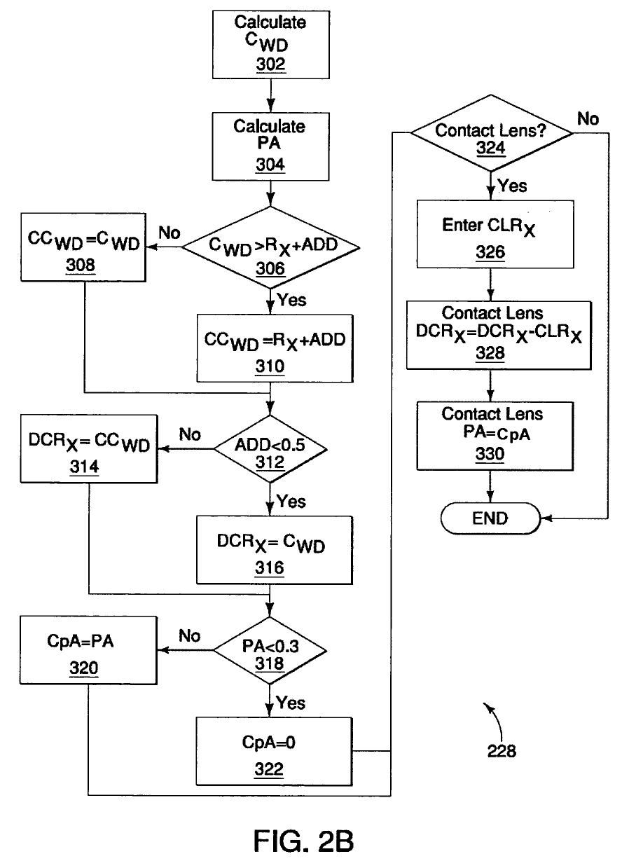

Eyeglass wearers using computers, though, present different needs from normal, “every day” eyeglasses. Computer use presents a medium distance/field/vision difficulty not often accounted for by lens prescriptions. Specifically, according to the present invention, the topologies and curvatures of the sides 102 and 104 (i.e. the lens prescription or lens characteristics) are varied to account for height, age, and so forth so as to provide a lens that will reduce incidences of headaches and eyestrain when the wearer uses a computer. Referring to FIG. 2A of the drawings, the reference numeral 200 generally designates a flow chart depicting the method of determining the lens characteristics for these lens (of FIGS. 1A and 1B) adapted for use with a computer.

This process can be done without computing tools; however, for the sake of convenience and efficiency, this method is performed in an electronic data processing system or computer. To make the calculation, a number of physical characteristics about the wearer or user are determined and then entered into the computer. In particular, the calculation uses the wearer's age (A) (entered in step 202), the wearer's height (H) (entered in step 204), the wearer's distance lens prescription (Rₓ) (entered in step 206), the wearer's average computer work distance (WD) (entered in step 208), and the wearer's bifocal power (ADD) (entered in step 209).

Each of the physical characteristics, themselves, may not be sufficient to determine the necessary lens characteristics. Specifically, the age alone may simply not be sufficient and may need to be modified. Thus, in steps 210 through 220, the corrected age is calculated and is represented by the following expressions:

CA=30, if Age<30 (2)

CA=Age, if 30≦Age≦60 (3)

CA=60, if Age>60 (4)

Namely, a determination is made in step 210 if a wearer is less than or equal to 30 years of age. If so, in step 212, the corrected age is equal to 30. Otherwise, a further determination is made in step 214 as to whether a user is between 30 and 60 years of age. If so, in step 216, the corrected age is equal to the wearer's age. Otherwise, in steps 218 and 220, the corrected age is 60.

One other physical characteristic that is modified is the height of the wearer. Based on the height (H), an adjusted number or height factor (H_{f}) is calculated and the formulas are as follows:

H_{f}=0, if H≧75 (5)

H_{f}=0.75-0.01*H, if H<75 (6)

Based on this formula, the height factor provides an adjusted number for a person under 75 inches tall. The reason for this adjusted number is that for a very tall person (notably over 75 inches tall), the distance from the screen is greater than for a shorter person. In addition, height is an important determinant on the ergonomic demands of the computer user. Thus, the prescription is adjusted slightly because shorter persons are nearer to the screen. Specifically, in step 222, a determination is made as to whether the wearer's height is greater than or equal to 75 inches. If so, in step 224, the height factor is set to 0. Otherwise, the height factor is calculated in accordance with equation (6) above in step 226.

Once all of the relevant factors have been calculated, the lens power is calculated in step 228. Referring to FIG. 2B of the drawings, the calculation of the lens power (step 228) is depicted in more detail.

In step 302, the computer work distance prescription (C_{WD}) is calculated. The formula for calculating C_{WD} is as follows:

$${C}_{WD} = \frac{CA}{WD} * 0.01 + {R}_{x} + {H}_{f} \qquad ( 7 )$$

This formula essentially allows one to determine the topologies and arcuate profiles of lens 100. In other words, equation (7) above calculates the total lens power in the absence of or with a small bifocal power, allowing an optometrist to vary the lens characteristics accordingly to allow the wearer to have a pair of eyeglasses specifically adapted for use with a computer.

Under conditions, though, where a wearer uses stronger bifocal lenses, C_{WD} is insufficient as a sole lens characteristic. The reason for the insufficiency is that bifocal lenses allow a wearer to have different lens powers for different distances, i.e. infinite and less than 1 meter. As one can understand, the wearer's proximity to a computer monitor may fall within a distance between the lens powers, requiring one or both of the distance prescription and bifocal prescription to be adjusted accordingly.

When a bifocal is used by a wearer, a computer preadd (PA) is calculated in addition to C_{WD} in step 304. In particular, the formula for calculating PA is as follows:

PA=Rₓ+ADD−C_{WD} (8)

### This formula determines a precursor that is employed in later determining the bifocal power of a lens adapted for use with a computer.

Once PA has been calculated, a determination is made as to the value of a corrected C_{WD} (CC_{WD}) in steps 306, 308, and 310. Specifically, in step 306, C_{WD} is compared against the sum of Rₓ and ADD. If C_{WD} is greater than the sum of Rₓ and ADD, then CC_{WD} is equal to C_{WD} (step 308). Otherwise, CC_{WD} is equal to the sum of Rₓ and ADD (step 310).

Then, the Distance Computer Prescription (DCRₓ) or spherical base and cylindrical strength is calculated based on the value of the ADD. Specifically, in step 312, a determination is made as to if ADD is less than 0.5. If ADD is less than 0.5, then DCRₓ is equal to C_{WD} (total lens power in the absence of or with a small bifocal power as stated above) in step 316. Otherwise, DCRₓ is equal to CC_{WD} in step 314.

In addition to calculating the DCRₓ, the bifocal power for the computer use lenses (CpA) is determined in steps 318, 320, and 322. In step 318, a determination is made as to whether PA is less than 0.3. If so, CpA is equal to PA (step 320). Otherwise, CpA is zero (step 322).

Furthermore, the above method can be further applied to contact lenses. In step 324, a determination is made as to if contact lenses are used, and in step 326 the contact lens prescription (CLRₓ) is entered. The contact lens DCRₓ is set equal to DCRₓ (calculated in steps 312, 314, and 316) minus CLRₓ in step 328. Additionally, the contact lens bifocal power is set equal to CpA in step 330.

Thus, an optometrist is able to easily calculate all of the lens characteristics that are standard components of lens prescriptions for these lenses that are adapted for use with a computer. More particularly, the optometrist can utilize a very simple automated system or program to calculate large numbers of prescriptions for lenses adapted for use with computers with ease and with a reduced number of errors.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method in an electronics data processing system for determining characteristics for lenses adapted for use with computers, comprising:
inputting a plurality of physical characteristics of a human user into the system, wherein the physical characteristics at least include a distance prescription and a work distance;
calculating a corrected age and a height factor from at least one of the physical characteristics; and
calculating a computer work distance prescription, wherein the computer work distance prescription is a function of:
a ratio of the corrected age and work distance;
the distance prescription; and
the height factor.

2. The method of claim 1, wherein the step of calculating the corrected age further comprises:
receiving an age of the user;
determining if the user's age is less than or equal to 30;
assigning the corrected age to be 30 if the user's age is less than 30;
determining if the user's age is greater than 30 but less than 60;
assigning the corrected age to be the user's age if the user's age is greater than 30 but less than 60;
determining if the user's age is greater than or equal to 60; and
assigning the corrected age to be 60 if the user's age is greater than or equal to 60.

3. The method of claim 1, wherein the step of calculating the height factor further comprises:
receiving a height of the user;
determining if the user's height is greater than or equal to 75 inches;
determining the height factor to be 0 if the user's height is greater than or equal to 75 inches; and
calculating the height factor as a function of the user's height for all heights less than 75 inches.

4. The method of claim 1, wherein the step of calculating the computer work distance prescription further comprises summing the ratio of the corrected age and work distance, the distance prescription, and the height factor.

5. The method of claim 1, wherein the method further comprises establishing a work distance and a distance prescription for the user.

6. The method of claim 1, wherein the step of calculating the computer work distance prescription further comprises calculating the lens power by summing one percent of the ratio of the corrected age and work distance with the height factor, the distance prescription.

7. A system for providing characteristics for lenses adapted for use with computers, comprising:
means for inputting a plurality of physical characteristics of a human user into the system, wherein the physical characteristics at least include a distance prescription and a work distance;
means for calculating a corrected age and a height factor from at least one of the physical characteristics; and
means for calculating a computer work distance prescription, wherein the computer work distance prescription is a function of:
a ratio of the corrected age and work distance;
the distance prescription; and
the height factor.

8. The system of claim 7, wherein the means for calculating the corrected age further comprises:
means for receiving an age of the user;
means for determining if the user's age is less than or equal to 30;
means for assigning the corrected age to be 30 if the user's age is less than 30;
means for determining if the user's age is greater than 30 but less than 60;
means for assigning the corrected age to be the user's age if the user's age is greater than 30 but less than 60;
means for determining if the user's age is greater than or equal to 60; and
means for assigning the corrected age to be 60 if the user's age is greater than or equal to 60.

9. The system of claim 7, wherein the means for calculating the height factor further comprises:
means for receiving a height of the user;
means for determining if the user's height is greater than or equal to 75 inches;
means for determining the height factor to be 0 if the user's height is greater than or equal to 75 inches; and
means for calculating the height factor as a function of the user's height for all heights less than 75 inches.

10. The system of claim 7, wherein the means for calculating the computer work distance prescription further comprises means for summing the ratio of the corrected age and work distance, the distance prescription, and the height factor.

11. The system of claim 7, wherein the system further comprises means for establishing a work distance and a distance prescription for the user.

12. The system of claim 7, wherein the means for calculating the computer work distance prescription further comprises means for calculating the lens power by summing one percent of the ratio of the corrected age and work distance with the height factor, the distance prescription.

13. A lens for a human user adapted for use with computers comprising a refractive material having a first side and an opposite second side, wherein each of the first and second sides has a topology and an arcuate profile, and wherein the topologies and arcuate profiles of the first and the second sides are functions of:
a ratio of a corrected age and a work distance of the user;
a distance prescription of the user; and
a height factor of the user.

14. The lens of claim 13, wherein the lens is tinted blue, yellow, rose, or lavender.

15. The lens of claim 13, wherein the corrected age is:
30, if a user's age is less than 30;
the user's age is greater than 30 but less than 60;
60, if the user's age is greater than or equal to 60.

16. The lens of claim 13, wherein the height factor is:
0, if the user's height is greater than or equal to 75 inches; and
a function of the user's height for all heights less than 75 inches.

17. The lens of claim 13, wherein the topologies and arcuate profiles of the first and the second sides are a sum the of ratio of the corrected age and work distance, the distance prescription, and the height factor.
